(19) United States
(12) Patent Application Publication
(10) Pub. No.: US 2026/0028934 A1
(43) Pub. Date: Jan. 29, 2026

(54) ELECTROLYSIS ENERGY RECOVERY

(71) Applicant: RTX Corporation, Farmington, CT (US)

(72) Inventors: Neil J. Terwilliger, Cheshire, CT (US); Joseph B. Staubach, New Britain, CT (US); Walter A. Ledwith, Jr., Marlborough, CT (US)

(21) Appl. No.: 18/994,767

(22) PCT Filed: Jul. 21, 2022
(86) PCT No.: PCT/US2022/037863

§ 371 Date: Jan. 15, 2025

(51) Int. Cl. F02C 3/22; C25B 1/04; C25B 15/08; F02C 3/30

(52) U.S. Cl. CPC F02C 3/22; C25B 1/04; C25B 15/081; F02C 3/30; F05D 2220/76; F05D 2240/35

(57) ABSTRACT

An energy supply system includes an electrolysis system to perform electrolysis on a first source of water, and break the water into hydrogen and oxygen components. The hydrogen and oxygen components are supplied to a power generation system. The power generation system includes a combustor receiving the hydrogen and oxygen components and is operable to combust the hydrogen and oxygen components. The combustor also receives a source of steam. Products of combustion downstream of the combustor pass over a top turbine rotor, driving the top turbine rotor to rotate. A first generator generates electricity from the rotation of the top turbine rotor.

### BACKGROUND OF THE INVENTION

This application related to an energy supply system using electrolysis to generate hydrogen and oxygen for use in combustion.

Electrical grids are required to supply electricity for any number of locations. As an example, homes, businesses, structures and buildings are supplied with energy from an energy grid.

Several types of power plants may provide electricity to the grid. As an example, nuclear energy, solar and wind energy, and fossil fuel are all utilized to generate electricity which is supplied to an electric grid.

In some cases, the supply of electricity to the grid has failed or is generated in insufficient quantity. This is undesirable, and it would be desirable to develop a reliable source of backup energy to power a grid in such instances.

In other cases, particularly with electricity produced by solar and wind, the energy conversion devices must be over-sized to account for variations in the wind or times when the sun is not shining. But these oversized systems can sometimes convert excess energy, more than the grid can utilize and cannot be economically turned off. The grid would benefit from having a mechanism to store this excessive energy for times of low energy conversion.

In at least one proposed system, water is subject to electrolysis, to break it into its hydrogen and oxygen components. The separated hydrogen and oxygen are then directed into a combustor of an engine where they are mixed and ignited.

Products of this combustion pass downstream over a turbine rotor, driving the rotor to rotate. This generates electricity which may be captured with a generator. Downstream of the combustor, the separated hydrogen and oxygen will have been returned to a water state.

The captured water may be sent to the combustor. The captured water may also be returned to a source of water for the electrolysis.

While such a system has potential benefits in reducing emissions, there are shortcomings in the proposed design.

### SUMMARY OF THE INVENTION

In a featured embodiment, an energy supply system includes an electrolysis system to perform electrolysis on a first source of water, and break the water into hydrogen and oxygen components. The hydrogen and oxygen components are supplied to a power generation system. The power generation system includes a combustor receiving the hydrogen and oxygen components and is operable to combust the components. The combustor also receives a source of steam. Products of combustion downstream of the combustor pass over a top turbine rotor, driving the top turbine rotor to rotate. A first generator generates electricity from the rotation of the top turbine rotor.

In another embodiment according to the previous embodiment, an evaporator is positioned to receive the products of combustion downstream of the turbine. A second source of water also passes through the evaporator such that the products of combustion boil the water passing through the evaporator. The water passing through the evaporator is supplied as the steam to the combustor.

In another embodiment according to any of the previous embodiments, a condenser is positioned to receive the products of combustion downstream of the evaporator. The products of combustion are condensed into liquid water by cooling the products of combustion with a cooling fluid. The liquid water supplied from the condenser passes to a pump for pressurization. Pressurized water is supplied to the evaporator as a second source of water.

In another embodiment according to any of the previous embodiments, a working fluid in the condenser is used to preheat the hydrogen and oxygen components being sent to the combustor.

In another embodiment according to any of the previous embodiments, the liquid water recovered from the products of combustion at the condenser is also sent to the first source of water.

In another embodiment according to any of the previous embodiments, the liquid water recovered from the products of combustion at the condenser is also sent to the first source of water.

In another embodiment according to any of the previous embodiments, steam from a second source of water is also selectively injected into the turbine.

In another embodiment according to any of the previous embodiments, water from a second source of water upstream of the evaporator is also selectively delivered into the products of combustion intermediate the combustor and the turbine.

In another embodiment according to any of the previous embodiments, a controller controls the electrolysis system and the power generation system and is programmed to determine an amount of electricity generation by other electricity generating systems, determine the electricity needs of an electric grid, and perform at least one of based on a determination that the amount of electricity generation exceeds the electricity needs of the grid, operate the electrolysis system and disengage the power generation system or based on a determination that the amount of electricity generation is less than the determined electricity needs of the grid, stop operation of the electrolysis system and run the power generation system

In another embodiment according to any of the previous embodiments, the hydrogen and oxygen components are cooled and stored in a liquid state before being supplied to the combustor.

In another embodiment according to any of the previous embodiments, the hydrogen and oxygen components are preheated before being delivered to the combustor.

In another embodiment according to any of the previous embodiments, the hydrogen and oxygen components are preheated before being delivered to the combustor.

In another embodiment according to any of the previous embodiments, the products of combustion are used for the preheating the hydrogen and oxygen components.

In another embodiment according to any of the previous embodiments, the preheating of the oxygen and hydrogen components occurs at the evaporator.

In another embodiment according to any of the previous embodiments, a steam turboexpander extracts work from the steam before delivering it to the combustor and the steam turboexpander driving a second generator.

In another embodiment according to any of the previous embodiments, electricity generated by the first and second generators is selectively supplied to an electric grid.

In another embodiment according to any of the previous embodiments, a bottoming cycle is provided with a bottoming fluid passing through the evaporator to be heated, with the bottoming fluid downstream of the evaporator passing over a bottoming turbine. The bottoming fluid downstream of the bottoming turbine passes through the condenser to be cooled, and the bottoming fluid downstream of the condenser returns to the evaporator the bottoming turbine driving a third generator.

In another embodiment according to any of the previous embodiments, power to drive the electrolysis system is provided from a source of electricity from a location outside the energy supply system.

In another embodiment according to any of the previous embodiments, water is separated from the products of combustion, and the separated water is returned to a second source of water.

In another embodiment according to any of the previous embodiments, a steam turboexpander extracts work from the steam before delivering it to the combustor and the steam turboexpander driving a second generator, and electricity generated by the first and second generators is supplied to an electric grid.

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1A shows a power supply system.

FIG. 1B shows a distinct embodiment heat exchanger that preheats both water and oxygen.

FIG. 2 shows an electrolysis system utilized in combination with the FIG. 1 system.

FIG. 3 is a control flow chart.

### DETAILED DESCRIPTION

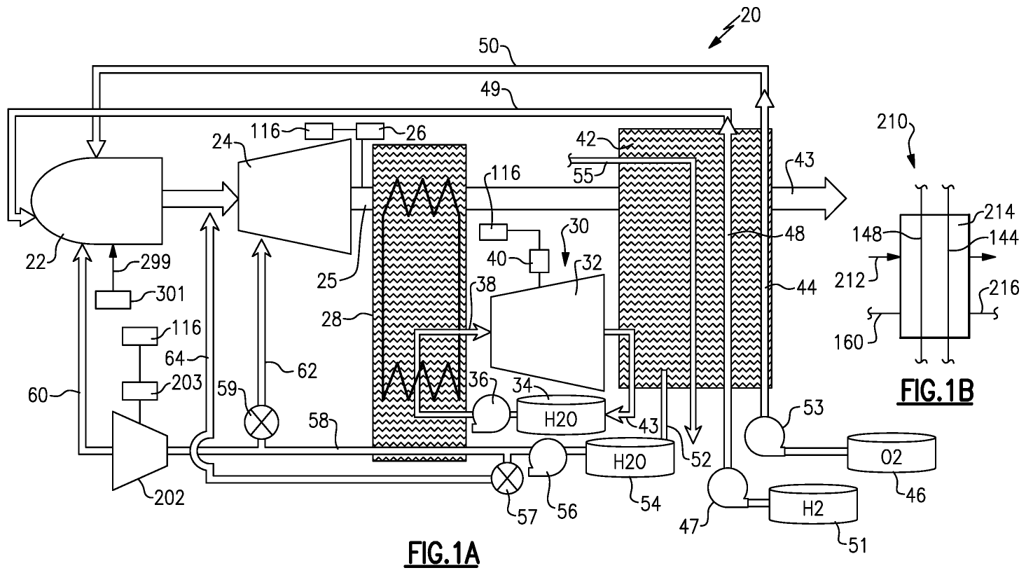

A power supply system 20 is illustrated in FIG. 1A. A combustor 22 receives a source of hydrogen 51 through line 49 and a source of oxygen 46 through line 50. The hydrogen and oxygen may be maintained at a cryogenic temperature such that they are in a liquid state. Alternatively, the hydrogen and oxygen may be in a gaseous state. The hydrogen and oxygen are mixed in the combustor 22 and ignited.

From the combustor 22, products of combustion pass downstream over a turbine rotor 24 driving a shaft 25 to rotate. A generator 26 is shown schematically, and electricity is generated by the rotation of the shaft 25. The electricity may be supplied to a use 116, such as an electric grid.

The products of combustion also pass through an evaporator 28, and through an optional condenser 42. Downstream of the condenser 42 the products of combustion 43 leave the system. Desirably there should be effectively zero products of combustion at point 43, although practically speaking there may be some small quantity of liquid water or steam.

The evaporator 28 heats water from a source of water 54 that passes through a line 58. Pump 56 may drive the water. The heated water turns to steam and is delivered into the combustor 22 at line 60.

The heated water also passes to the turbine 24 at line 62. A valve 59 controls this flow. Steam and/or water is sent to turbine 24 for buffer flow or cooling. The valve 59 could control the steam flow between the turbine and combustor for managing combustion temperature, turbine cooling need, and combustion limits such as a concern of extinguishing the flame if too much steam is added.

A branch line 64 branches off of the water supply line upstream of the evaporator 28 such that water that has not been heated is provided to a location intermediate the combustor 22 and the turbine 24. A valve 57 controls this flow. Valve 57 controls the ratio of steam and water. Water may be useful for specific cooling purposes in the turbine. Secondly, by allowing some water to bypass the evaporator. A control can ensure that lines 60 and 62 contain only steam. If too much water was sent to the evaporator so that some was not boiled, liquid water could make its way where it is not intended to be, such as entering the turboexpander 202.

An optional bottoming main cycle 30 includes a bottoming turbine 32 and a source of water 34. A pump 36 drives the water through the evaporator 28 in a line 38. This water is heated to steam, and that steam drives the turbine 32. As shown, a generator 40 generates electricity from the rotation of the turbine 32. Downstream of the turbine 32 the water returns to the source 34 through a line 43.

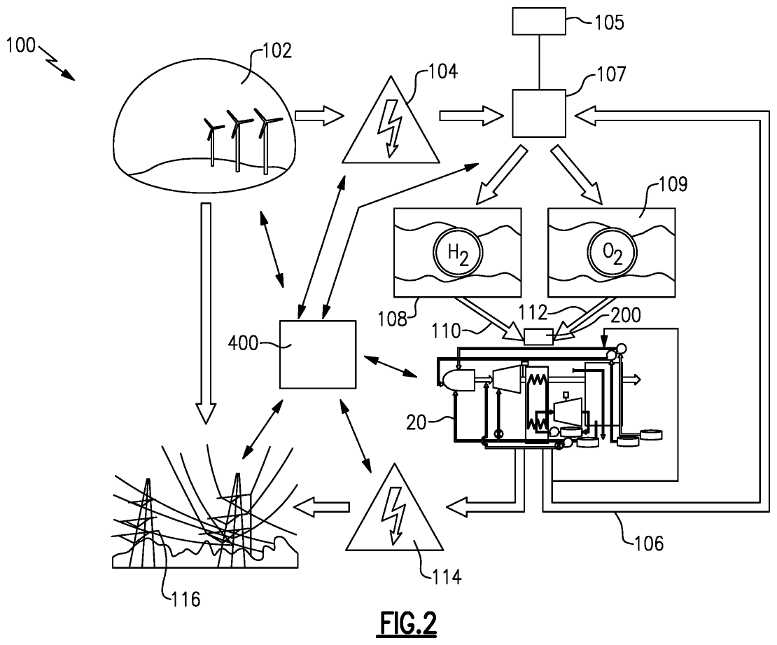

The control for the valves, the supply of electricity to the grid, the flow and operation of the entire system 20 may be incorporated into an overall grid power supply control as will be described in FIG. 2.

A steam turboexpander 202 is shown on the line 60, and expands the steam being delivered to the combustor 22. The turboexpander 202 drives a generator 203 that may also supply electricity to the use 116 (e.g., an electrical grid).

The generators 26, 40 and 203 may be utilized to generate electricity for times when electricity is needed such as by an electrical grid 116, shown schematically.

The water for the source 54 may in part be received at line 52 from water which has been separated out of the products of combustion in the condenser 42. An alternative source of steam 299 may be sent to the combustor 22, rather than from evaporator 28. As an example a separate boiler 301 may be used.

An additional source of cooling fluid 55 may pass through the condenser 42. This additional source may be air, or could be environmental water such as river water. This further serves to cool the products of combustion, and remove more of the water, reducing the remaining products of combustion reaching point 43.

Line 44 from the source of oxygen 46 passes through the condenser 42 and is heated by the products of combustion. Pump 53 is the source of pressure to drive the heated oxygen into the combustor 22. Similarly, hydrogen from source 51 passes through the condenser 42 at line 48. Pump 47 is the source of pressure to drive the heated hydrogen into the combustor 22.

FIG. 1B shows another embodiment 210 for heat exchange between fluids. In embodiment 210 the steam generation from the source of water 216 to a line 160 heading to the combustor 22 passes through a heat exchanger 214. Heat exchanger 214 may be generally at the location of evaporator 28. Products of combustion at 212 extend across the heat exchanger 214 to heat the water from the source 216 and create steam for line 160. In addition, a line 144 passes the oxygen from source 46 through this same heat exchanger 214 for preheating by the products of combustion. Similarly, line 148 connects to the source of hydrogen 51, which is preheated in the heat exchanger 214.

That is, while two heat exchangers perform the steam generation and preheat function in the FIG. 1A embodiment, both functions can occur in a single heat exchanger. Embodiment 210 may otherwise operate like the FIG. 1A system. In other words, the preheat of the fuel and oxidizer can alternatively be accomplished in the evaporator, for example when water is available without a condenser.

The overall system 20 provides very efficient generation of electricity. The use of liquid hydrogen and liquid oxygen provides more efficient power generation than gaseous oxygen and hydrogen. However, the energy cost to bring the gaseous oxygen and hydrogen to the liquid state may suggest that gaseous oxygen and hydrogen be utilized.

There is a need for additional and reliable generation of electricity. The disclosed system relies generally on established and known technologies, but yet assembled in a unique arrangement.

As alternative sources to generate large amounts of electricity, massive battery systems are often considered. However, such technologies would still need to be developed. In addition, the disclosed system 20 would rely upon materials that are more generally available as compared to materials which would be required for such proposed battery systems. With electric vehicles and other proposed electric systems, battery materials such as lithium are being pursued competitively for other uses, and thus would be more difficult to obtain in sufficient quantities for widespread use in grid-scale energy storage.

Further, there is zero or near zero net water use. The little water that is exhausted from the system could be in liquid form. While water vapor is a greenhouse gas in the atmosphere, there is virtually none emitted from this system. Thus there is zero greenhouse gas emission.

In addition, there is zero greenhouse gas generation. The generation of electricity from hydrogen in the proposed system would be above 70% in overall efficiency. This is much higher than fuel cells, industrial gas turbines, etc. In addition, the disclosed system 20 can power up rapidly and power down rapidly as needed to supply intermittent generation of electricity from a renewable source.

As shown in FIG. 2, an electric grid 116 is illustrated. The system 20 is shown supplying electricity at 114 to the grid 116.

Other conventional sources of electric generation, such as wind turbines 102, also provide electricity to the grid 116. While wind turbines are shown, it should be understood that all sources of electric generation, including standard power generation plants would be considered part of the electric generation systems 102. The water source 105 is illustrated here supplying water to an electrolysis system 107. Energy at 104, which may be provided by the conventional power generation systems 102, powers electrolysis system 107 on water 105 breaking it into hydrogen 108 and oxygen 109 components.

The electrolysis system 107 may be as known. Those components are then supplied at 110 and 112 to the respective storage sources 51 and 46. The components 108 and 109 may be liquefied by a refrigerant system 200 so as to be stored in liquid phase in 51 and 46. Waste heat from the refrigerant system 200 may be reused in different parts of the process, such as in preheating the water for electrolysis. The refrigerant system 200 and waste heat re-use may be as known.

As shown in this Figure, the water for source 105 may come from a return line 106 from the system 20. In that sense, the water circuit herein may be a closed loop. On the other hand, an open loop system is also within the scope of this disclosure.

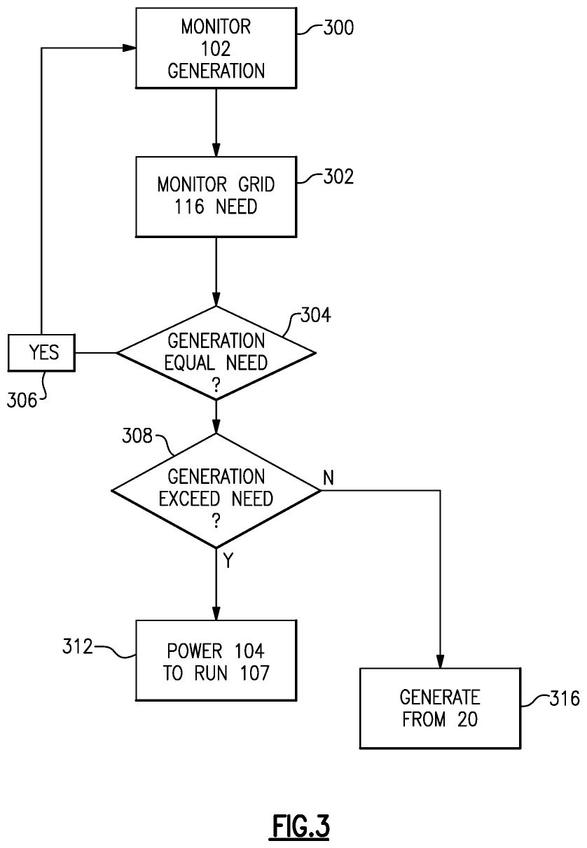

As mentioned above, a controller 400 for the system shown in FIG. 2 will control the power generation system 20, the electrolysis process 107, and all of the operation disclosed across the system shown in FIG. 2. A proposed method of operation is disclosed below, and it should be understood the controller 400 would be programmed to affect the FIG. 3 operation and control.

A flow chart for operating the system shown in FIG. 2 is disclosed in FIG. 3. In general, the electrolysis system 107 and the power generation by system 20 may not occur simultaneously. As an example, if the energy generated by sources 102 is below the needs of the grid 116, then system 20 is operated to supply additional electricity at 114. However, if energy generation by sources 102 is above the needs of grid 116 then the excess energy is utilized at 104 to drive the electrolysis system 107. The operating system of FIG. 3 is thus configured to ensure stable grid operation.

In that sense, the generated oxygen 109 and hydrogen 108 may be stored such as in the liquid state for a period of time until power generation is needed, and then the oxygen and hydrogen will be sent to the combustor 22.

FIG. 3 shows a flow chart. At step 300, controller 400 monitors the volume of electric generation by the systems 102. At step 302, the controller 400 monitors the electric needs of grid 116. At step 304, the controller 400 determines whether the monitored generation electricity equals the grid need. If the answer is yes, at step 306, the system returns to step 300.

If the controller 400 determines, at step 304, that the monitored generation electricity is not equal to the grid need, the controller 400, at step 308, determines whether the monitored generation electricity exceeds the grid 116 need.

Based on a determination that an excess amount of electricity is being produced, at step 312, the controller 400 supplies power at 104 to run the electrolysis system 107. As mentioned above, during this step the power system 20 is preferably not operated.

If the determination at step 308 is that the electricity generated does not exceed the grid need, then the controller 400 determines the generated electricity is less than the need. Based upon such a determination, at step 316, the controller 400 generates power from system 20, with the electrolysis system 107 shutdown.

The disclosed hydrogen/oxygen engine has higher thermal efficiency than existing electric generation systems such as a combined cycle gas turbine or a fuel cell. One reason is there is no gaseous nitrogen compression that does not provide corresponding power in such a system. However, the temperatures of pure H2 and O2 combustion are high. Thus, the steam injection lowers the temperature and assists in the combustor surviving more manageable temperatures.

The proposed system improves upon the prior art in several ways. First, the injection of steam into the combustor allows the combustor to survive the very high temperatures it is likely to see.

In addition, the proposed system increases its efficiency by generating heat for such steam from an evaporator where it is heated by waste heat from the turbine 24. Further, the optional use of liquid hydrogen and liquid oxygen to condense the water further increases the efficiency of the system 20 by recovering that heat of condensation into the combustor 22.

In addition, the preheating of the liquid oxygen and hydrogen heading to the combustor provides benefits over the prior art.

As an additional benefit this system reduces the greenhouse gas emissions compared to conventional power generation systems.

An energy supply system under this disclosure could be said to include an electrolysis system to perform electrolysis on a first source of water, and break the water into hydrogen and oxygen components. The hydrogen and oxygen components are supplied to a power generation system. The power generation system includes a combustor receiving the hydrogen and oxygen components and is operable to combust the hydrogen and oxygen components. The combustor also receives a source of steam. Products of combustion downstream of the combustor pass over a top turbine rotor, driving the top turbine rotor to rotate. A first generator generates electricity from the rotation of the top turbine rotor.

Although embodiments of this disclosure have been shown, a worker of ordinary skill in this art would recognize that modifications would come within the scope of this disclosure. For that reason, the following claims should be studied to determine the true scope and content of this disclosure.

What is claimed is:

1. An energy supply system comprising:
an electrolysis system to perform electrolysis on a first source of water, and break the water into hydrogen and oxygen components, said hydrogen and oxygen components being supplied to a power generation system;
said power generation system including a combustor receiving the hydrogen and oxygen components and being operable to combust the hydrogen and oxygen components;
said combustor also receiving a source of steam; and
products of combustion downstream of the combustor passing over a top turbine rotor, driving the top turbine rotor to rotate, and a first generator for generating electricity from the rotation of the top turbine rotor.

2. The energy supply system as set forth in claim 1, wherein an evaporator is positioned to receive the products of combustion downstream of the turbine, and a second source of water also passing through said evaporator such that the products of combustion boil the water passing through the evaporator, and the water passing through the evaporator is supplied as the steam to the combustor.

3. The energy supply system as set forth in claim 2, wherein:
a condenser is positioned to receive the products of combustion downstream of the evaporator,
the products of combustion are condensed into liquid water by cooling the products of combustion with a cooling fluid,
the liquid water supplied from the condenser passes to a pump for pressurization, and
pressurized water is supplied to the evaporator as a second source of water.

4. The energy supply system as set forth in claim 3, wherein a working fluid in the condenser is used to preheat the hydrogen and oxygen components being sent to the combustor.

5. The energy supply system as set forth in claim 4, wherein the liquid water recovered from the products of combustion at the condenser is also sent to the first source of water.

6. The energy supply system as set forth in claim 3, wherein the liquid water recovered from the products of combustion at the condenser is also sent to the first source of water.

7. The energy supply system as set forth in claim 2, wherein steam from a second source of water is also selectively injected into the turbine.

8. The energy supply system as set forth in claim 2, wherein water from a second source of water upstream of the evaporator is also selectively delivered into the products of combustion intermediate the combustor and the turbine.

9. The energy supply system as set forth in claim 1, wherein a controller controls the electrolysis system and the power generation system and is programmed to:
determine an amount of electricity generation by other electricity generating systems,
determine the electricity needs of an electric grid, and
perform at least one of:
based on a determination that the amount of electricity generation exceeds the electricity needs of the grid, operate the electrolysis system and disengage the power generation system; or
based on a determination that the amount of electricity generation is less than the determined electricity needs of the grid, stop operation of the electrolysis system and run the power generation system.

10. The energy supply system as set forth in claim 1, wherein the hydrogen and oxygen components are cooled and stored in a liquid state before being supplied to the combustor.

11. The energy supply system as set forth in claim 10, wherein the hydrogen and oxygen components are preheated before being delivered to the combustor.

12. The energy supply system as set forth in claim 1, wherein the hydrogen and oxygen components are preheated before being delivered to the combustor.

13. The energy supply system as set forth in claim 12, wherein the products of combustion are used for the preheating the hydrogen and oxygen components.

14. The energy supply system as set forth in claim 12, wherein the preheating of the oxygen and hydrogen components occurs at the evaporator.

15. The energy supply system as set forth in claim 1, wherein a steam turboexpander extracts work from the steam before delivering it to the combustor and the steam turboexpander driving a second generator.

16. The energy supply system as set forth in claim 15, wherein electricity generated by the first and second generators is selectively supplied to an electric grid.

17. The energy supply system as set forth in claim 1, wherein a bottoming cycle is provided with a bottoming fluid passing through the evaporator to be heated, with the bottoming fluid downstream of the evaporator passing over a bottoming turbine, and the bottoming fluid downstream of the bottoming turbine passing through the condenser to be cooled, and the bottoming fluid downstream of the condenser returning to the evaporator the bottoming turbine driving a third generator.

18. The energy supply system as set forth in claim 1, wherein power to drive the electrolysis system is provided from a source of electricity from a location outside the energy supply system.

19. The energy supply system as set forth in claim 1, wherein water is separated from the products of combustion, and the separated water is returned to a second source of water.

20. The energy supply system set forth in claim 19, wherein a steam turboexpander extracts work from the steam before delivering it to the combustor and the steam turboexpander driving a second generator, and electricity generated by the first and second generators is supplied to an electric grid.
